(19) United States
(12) Patent Application Publication
(10) Pub. No.: US 2008/0136227 A1
(43) Pub. Date: Jun. 12, 2008

(54) VEHICLE SEAT SENSOR ASSEMBLY

(75) Inventors: Jeffrey A. Lim, Austin, TX (US); Sywong Ngin, Austin, TX (US); Charles Mitchell, Austin, TX (US); Patrick C. Howard, Austin, TX (US); Pete D. Jordan, Cedar Creek, TX (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/609,163

(22) Filed: Dec. 11, 2006

(51) Int. Cl. B60N 2/00

(52) U.S. Cl. 297/217.3

(57) ABSTRACT

A seat assembly includes a frame, a cushion and a sensor assembly. The cushion is positioned on the frame and includes a top surface and a bottom surface. The sensor assembly includes a capacitive sensing element and is positioned on one but not both of the top surface and bottom surface of the cushion.

### BACKGROUND

Sensor assemblies may be used to monitor the position, orientation, presence, or size of a person or object within a defined space. The position, orientation, presence, or size of a person or object in the defined space may affect the impedance around a sensing element of a sensor assembly. A current may be applied to one or more sensors, and an electronic control unit (“ECU”) may measure the impedance changes in an electric field around each sensing element in order to gather information about the position, orientation, presence, or size of a person. For example, a sensor assembly may be used in a vehicle seat to help regulate the deployment of air bags.

### SUMMARY

In a first aspect, the present invention is a seat assembly including frame, a cushion of foam positioned on the frame and having a bottom surface facing the frame and a top surface opposite the bottom surface. A sensor assembly includes at least one capacitive sensing element positioned on the top surface of the cushion.

In a further aspect, the present invention is a method of making a vehicle seat including providing a frame and a cushion of foam. The cushion is positioned on the frame and has a bottom surface facing the frame and a top surface opposite the bottom surface. A sensor assembly includes at least one capacitive sensing element and is positioned the top surface of the cushion.

In a further aspect, the present invention is a vehicle including a support structure and a seat assembly. The seat assembly includes a seat frame coupled to the support structure and a cushion of foam. The cushion of foam is positioned on the frame and has a bottom surface facing the frame and a top surface opposite the bottom surface. A sensor assembly includes at least one capacitive sensing element and is positioned on the top surface but not the bottom surface of the cushion. A seat cover covers the seat frame, cushion and sensor assembly such that the sensor assembly is positioned between the top surface and the seat cover.

The above summary is not intended to describe each disclosed embodiment or every implementation of the present invention. The figures and the detailed description which follow more particularly exemplify illustrative embodiments.

### BRIEF DESCRIPTION OF THE DRAWINGS

The present invention will be further explained with reference to the drawing figures listed below, where like structure is referenced by like numerals throughout the several views.

FIG. 1 is a schematic view of a vehicle.

FIG. 2 is an exploded view of a vehicle seat assembly.

FIG. 3 is a bottom perspective view of a sensor assembly.

While the above-identified figures set forth several embodiments of the invention, other embodiments are also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention.

### DETAILED DESCRIPTION

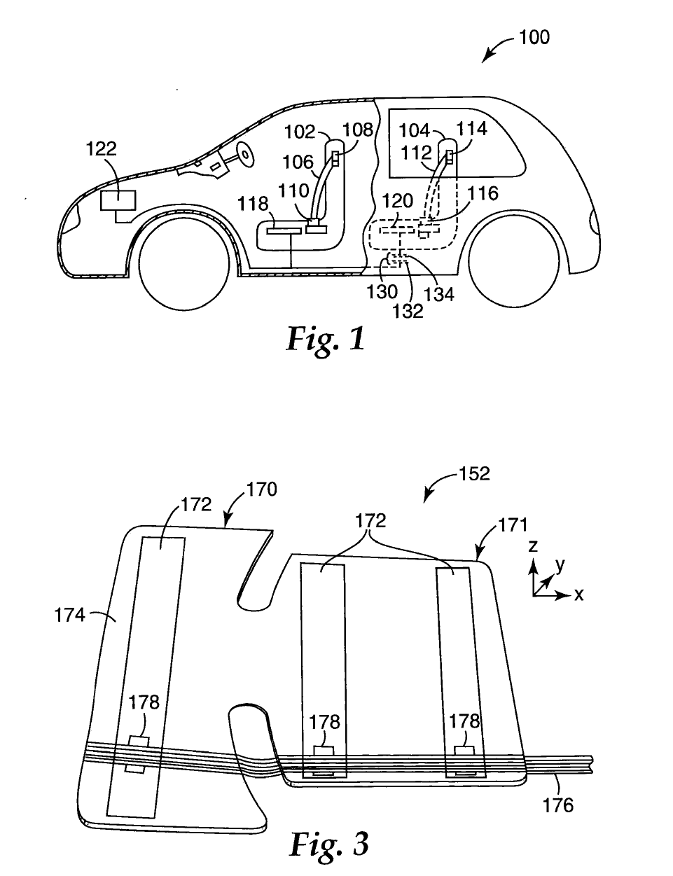

FIG. 1 is a schematic diagram of a vehicle 100. Vehicle 100 includes front seat assembly 102 and rear seat assembly 104 coupled to a support structure of vehicle 100. Reference will be made to a single front seat assembly 102 and a single rear seat assembly 104. However, multiple front and multiple rear seat assemblies are typically employed in vehicle 100, and each seat assembly may have one or more associated sensor assemblies discussed below. Front seat assembly 102 includes an associated seat belt 106. Seat belt 106 is coupled to a tensioner 108 and a buckle 110 for securing the seat belt. Similarly, back seat assembly 104 includes an associated seat belt 112 coupled to a tensioner 114 and buckle 116.

Front seat assembly 102 includes a seat occupancy sensor 118 and rear seat assembly 104 includes a seat occupancy sensor 120. Furthermore, vehicle 100 includes a battery 122. Battery 122 provides power to several components in vehicle 100 including seat occupancy sensors 118 and 120. Battery 122 can be directly coupled to seat occupancy sensor 118 using a suitable lead. Likewise, battery 122 can be directly coupled to seat occupancy sensor 120. However, in some instances, it may be desired for rear seat assembly 104 to be removable from a floor of vehicle 100. In this instance, power from battery 122 can be supplied through an inductive coupling 130. Inductive coupling 130 allows power to be transmitted between circuits 132 and 134, for example through a shared magnetic field. Thus, circuit 134 can be physically separated from circuit 132 during removal of seat 104 but can be easily recoupled to circuit 132 by placement of seat assembly 104 in its place within vehicle 100.

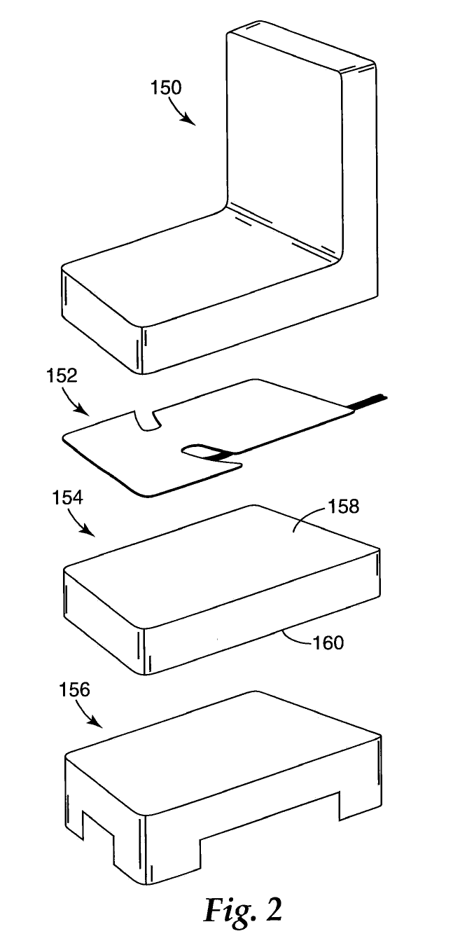

Seat occupancy sensors 118 and 120 include a sensing element having a thin profile to easily integrate into seats assemblies 102 and 104 without affecting their structure. FIG. 2 is an exploded schematic view of an exemplary seat assembly 102. Seat assembly 104 can be similarly configured. Assembly 102 includes a seat cover 150, a sensor assembly 152, a cushion 154 and a frame 156. Seat cover 150 is configured to cover sensor assembly 152, cushion 154 and frame 156. Sensor assembly 152 is positioned on a top surface 158 of cushion 154. Alternatively, sensor assembly 152 could be positioned on a bottom surface 160 of cushion 154. Bottom surface 160 faces frame 156 and is positioned thereon.

Assembly 102 can be assembled by providing frame 156 and positioning cushion 158 on frame 156. Cushion 154 can be mode of foam and includes top surface 158 (which is also referred to as the “A” surface) and bottom surface 160 (which is also referred to as the “B” surface). Sensor assembly 152 can be directly applied to top surface 158 without modifying the foam of cushion 154. Additionally, sensor assembly 152 can be fixed directly to seat cover 150 and then seat cover 150 can be positioned over cushion 154 and frame 156. Cushion 154 can also include other elements as desired. For example, cushion 154 can include a plush pad, one or more heating elements and/or one or more cooling elements.

As discussed below, sensor assembly 152 includes a sensor array and a carrier coupled to the sensor array. The sensor array includes at least one sensing element. A flexible multiconductor cable and an electrically conductive patch can be used to electrically connect the sensing element and a conductor of the cable. It is worth noting that any thin or low profile conductive element can be used for conducting electricity in assembly 152. The electrically conductive patch can be positioned between the cable and the sensing element. The cable may be used to connect the sensing element to an ECU. Alternatively, the sensing element can be designed with an integrated trace that can be used to transmit the signal to the ECU. Although the present invention is described in reference to a vehicle seat, other applications of the present invention in which it may be desirable to gather information about the position, orientation, presence, or size of a person within a defined space are also contemplated.

One flexible multiconductor cable that can be used is a flexible flat cable. A “flat cable” is a cable including a plurality of mutually insulated conductors, where the cable preferably has generally flat top and bottom surfaces and a non-cylindrical cross-section. The conductors are preferably aligned in a common plane rather than being grouped together or around a common axis to form a circular cross-section. The conductors are typically bound together (while being aligned in a common plane), which may increase the structural integrity and strain relief capabilities of the flat cable. The conductors may be any suitable shape, such as round or flat. Although a cable having a cylindrical cross-section may be used with the present invention, a flat cable is preferred because such a cable may be a more efficient use of space and a flat cable may be more comfortable to a vehicle occupant sitting on the vehicle seat.

A flat cable may also be preferred because of the substantially constant spacing between the conductors. That is, the spacing between the conductors of the flat cable remains substantially consistent because of the insulation material separating the conductors. The substantially constant spacing may increase the ability of an ECU, which is connected to the flat cable, to detect minor changes in impedance around a sensing element that is electrically connected to the flat cable. A suitable flat cable may be, but is not limited to, what is commonly referred to as a “ribbon” cable, which includes round conductors aligned parallel in a plane. The present invention may also reduce the number of individual wires required to connect the sensors to the ECU and simplify the connection process because a single cable having a plurality of mutually insulated conductors may be used.

The sensing element can be connected to a conductor of the cable using a conductive patch, which is positioned between the cable and sensing element. Preferably, each sensing element is electrically connected to a separate conductive patch and a separate conductor of the multiconductor cable so that the ECU is able to gather information from individual sensing elements. Any suitable sensing element may be used with the present invention. For example, the sensing element may be formed of an electrode antenna, as described in U.S. Pat. No. 6,683,583, entitled, “FLEXIBLE ELECTRODE ANTENNA”, and assigned to 3M Innovative Properties Company, St. Paul, Minn. Typically, more than one sensing element is used in the sensor assembly of the present invention (in a “sensor array”). The positioning of each sensing element in the array may vary depending upon the type of vehicle the sensor assembly is used in, or the particular application of the sensor assembly (e.g., whether the sensor assembly is being used to activate front air bags, side air bags, etc.).

The sensing element may be secured to a conductive patch using a suitable means, such as an adhesive. In embodiments where the sensing element is adjacent to the flat cable of the sensor assembly, the sensing element and flat cable may be secured together using a transfer adhesive (which is preferably nonconductive). Other suitable means may also be used to connect the flat cable and sensing element together. The adhesion of the flat cable to the sensing element may provide more rigidity and therefore, integrity, to the sensor assembly than if the flat cable and sensing element were not adhered together, and the added rigidity may be preferable if it adds to the integrity of the sensor assembly.

The conductive patch may be formed out of a conductive material. The conductive patch may be electrically conductive in either orthogonal x-y-z coordinate directions (see coordinates shown in FIG. 3) or in the z-coordinate direction. Examples of suitable materials for forming a conductive patch include, but are not limited to, a metallized nonwoven material (e.g., Product No. 9713, which is made commercially available by 3M Company, St. Paul, Minn.), a double-sided conductive tape (e.g., Product No. 1182, which is made commercially available by 3M Company, St. Paul, Minn.), a conductive transfer adhesive, and a conductive carbon nonwoven material (e.g., Product No. 9712, which is made commercially available by 3M Company, St. Paul, Minn.).

The conductive patch can provide a range of electrical connectivity points for the sensing element and conductor because it provides a relatively large target conductive surface for the conductor relative to the sensor. In this way, the conductive patch helps a single manufacturing process be applicable to a broad range of vehicle seats rather than being specific to a particular type of vehicle seat. The conductive patch may also simplify the process for connecting the sensing element to the conductor of the cable by enlarging the range of connectivity points, and because a separate eyelet and rivet connection step between a wire and sensor is no longer required. The conductive patch may have an adhesive on one side or both opposing sides in order to help secure the conductor to the conductive patch, and/or to help secure the sensing element to the conductive patch. For example, the conductive patch may be die cut from a roll of conductive material lined with a conductive adhesive, such as a pressure sensitive adhesive.

When a sensing element is used in conjunction with a seat, such as a vehicle seat having a cushion or any other suitable cushioning material, the present invention may be characterized as a “seat assembly.” The sensing element can maintain a thin profile and applied to only one surface of a cushion of the seat. For example, the thickness of the sensing element can be less than 0.5 inches, less than 0.25 inches, less than 0.125 inches or less than 0.0625 inches. The sensing element further can be attached to a seat cover or otherwise positioned between the seat cover and the cushion such that no modification of foam in the cushion is necessary. The sensing element can be coupled to a substantially liquid impervious, vapor permeable material covering at least a part of the sensing element, to form a sensor assembly. One example material covering is described in U.S. patent application Ser. No. 10/196,997, entitled “BREATHABLE MOISTURE BARRIER FOR AN OCCUPANT SENSING SYSTEM” and filed on Jul. 16, 2002.

In embodiments where the cushion, or other pad material, is adjacent to the flat cable of the sensing element, the cushion and flat cable may be secured together using an adhesive. For example, a transfer adhesive may be applied to opposing sides of a cable, where one side of the cable adheres to the cushion, and the opposing side of the cable may adhere to a substantially liquid impervious, vapor permeable material. The rigidity and integrity of the sensor assembly may increase when the flat cable is adhered (or otherwise secured) to the cushion and the substantially liquid impervious, vapor permeable material.

The figures are not drawn to scale. If drawn to scale, each flat cable would be much thinner (i.e., have a smaller z-coordinate dimension), because it is preferred that the flat cable have a small thickness so that the flat cable has a low profile relative to the cushion and does not itself protrude from the cushion or cause the cushion to protrude. As used herein, a “length” runs along the x-coordinate direction, a “width” runs along the y-coordinate direction, and a “thickness” runs along the z-coordinate direction.

FIG. 3 is a bottom perspective view of a sensor assembly 152 which can be applied to surface 158 of cushion 154. Sensor assembly 152 shows a general structure of a sensor assembly which may be incorporated into a vehicle seat. Sensor array 170 is formed of a set 171 (i.e. a plurality) of sensing elements 172 applied to a carrier 174. Each sensing element in the set of sensing elements 172 is electrically connected to an ECU (not shown in FIG. 3) using flat cable 176. Flat cable 176 is formed of a plurality of longitudinally-extending (i.e., extending in the x-coordinate direction) conductors insulated from each other by an insulating material. Preferably, each sensing element in sensor array 170 is electrically connected to a separate conductor in flat cable 176. Conductive patches 178 provide an electrical connection between sensing elements 172 and flat cable 176. Carrier 174 may be secured to at least part of flat cable 176 using a suitable means, such as an adhesive, thermal bonding, or a mechanical attachment.

Flat cable 176 does not protrude significantly in the z-coordinate direction from cushion 154, thereby adding to occupant comfort (when the occupant is sitting on a vehicle seat that includes sensor assembly 152). In current methods of connecting a sensing element to a wire using an eyelet and rivet connection, the sensing element does not typically run the width of the substrate because the eyelet and rivet connection is typically connected to one end of the sensing element, and that end of the sensing element is then positioned off to one side of the substrate (so that it is no longer centered on the cushion) so as not to cause discomfort to a vehicle occupant. In the present invention, the size of each sensing element may be increased. An increased sensing element size may increase the sensitivity of sensor assembly 152. Sensor assembly 152 is just one particular embodiment of a sensor assembly of the present invention. For example, sensor assembly 152 can include one or more sensing elements and include any type of conductor to electrically connect to the sensing elements.

Sensor assembly 152 can be included within seat assemblies of vehicle 100, for example as seat occupancy sensors 118 and 120. Thus, one or more of the seat assemblies within vehicle 100 can include an occupancy sensor that can monitor the position, orientation, presence and size of a person sitting on a particular seat assembly. Deployment of air bags can thus be more easily and efficiently regulated. Repacking of air bags can be expensive. Since many vehicles include multiple front, rear and/or side air bags, improper deployment of these bags can be expensive. By employing one or more sensor assemblies within the seat assemblies of a vehicle, airbag repacking costs can be reduced. Furthermore, the sensor assemblies can be used in combination with seat belt sensors to provided a signal when a vehicle occupant should wear a seat belt.

Although the present invention has been described with reference to preferred embodiments, workers skilled in the art will recognize that changes may be made in form and detail without departing from the spirit and scope of the invention.

What is claimed is:

1. A vehicle seat assembly, comprising:
a frame;
a cushion of foam positioned on the frame and having a bottom surface facing the frame and a top surface opposite the bottom surface; and
a sensor assembly including at least one capacitive sensing element positioned on the top surface and not the bottom surface of the cushion.

2. The assembly of claim 1 wherein a thickness of the sensor assembly is less than 0.25 inches.

3. The assembly of claim 1 and further comprising a seat cover covering the frame, the cushion and the sensor assembly.

4. The assembly of claim 3 wherein the sensor assembly is attached to the seat cover.

5. The assembly of claim 1 wherein the sensor assembly includes a plurality of capacitive sensing elements.

6. The assembly of claim 5 wherein the sensor assembly further comprises a cable electrically coupled to each of the plurality of sensing elements.

7. The assembly of claim 1 wherein the sensor assembly further comprises a carrier coupled to the at least one capacitive sensing element and formed of a substantially liquid impervious, vapor permeable material.

8. A method of making a vehicle seat, comprising:
providing a frame;
providing a cushion of foam, the cushion having a bottom surface facing the frame and a top surface opposite the bottom surface; and
positioning a sensor assembly having a capacitive sensing element on the top surface but not the bottom surface of the cushion.

9. The method of claim 8 wherein a thickness of the sensor assembly is less than 0.25 inches.

10. The method of claim 8 and further comprising:
providing a seat cover; and
covering the frame, the cushion and the sensor assembly with the seat cover.

11. The method of claim 10 and further comprising:
attaching the sensor assembly to the seat cover.

12. The method of claim 8 wherein the sensor assembly comprises a plurality of capacitive sensing elements and a conductor electrically coupled to each of the plurality of sensing elements.

13. The method of claim 8 and further comprising:
attaching the at least one capacitive sensing element to a carrier formed of a substantially liquid impervious, vapor permeable material.

14. A vehicle, comprising:
a support structure;
a seat assembly coupled to the support structure and including:
a seat frame coupled to the support structure;
a cushion of foam having a bottom surface facing the frame and a top surface opposite the bottom surface;
a sensor assembly having at least one capacitive sensor positioned on the top surface and not the bottom surface of the cushion; and
a seat cover covering the seat frame, cushion and sensor assembly such that the sensor assembly is positioned between the top surface and the seat cover.

15. The vehicle of claim 14, wherein a thickness of the sensor assembly is less than 0.25 inches.

16. The vehicle of claim 14 and further comprising a second seat assembly including:
a seat frame coupled to the support structure;
a cushion of foam having a bottom surface facing the frame and a top surface opposite the bottom surface;
a sensor assembly having at least one capacitive sensor positioned on the top surface of the cushion; and
a seat cover covering the seat frame, cushion and sensor assembly such that the sensor assembly is positioned between the top surface and the seat cover.

17. The vehicle of claim 16 wherein the second seat assembly is positioned behind the first-mentioned seat assembly.
